(19) United States
(12) Patent Application Publication
(10) Pub. No.: US 2004/0073664 A1
(43) Pub. Date: Apr. 15, 2004

(54) Method and system for monitoring DOCSIS RF networks

(76) Inventor: John R. Bestermann, Suwanee, GA (US)

Correspondence Address: ARRIS INTERNATIONAL, INC, 11450 TECHNOLOGY CIRCLE, DULUTH, GA, 30097, US

(21) Appl. No.: 10/676,490

(22) Filed: Oct. 1, 2003

Related U.S. Application Data
(60) Provisional application No. 60/415,344, filed on Oct. 1, 2002.

(51) Int. Cl. G06F 15/173; H04N 7/173

(52) U.S. Cl. 709/224; 725/111

(57) ABSTRACT

Server software running on a cable modem uses data samples being collected in a register by storing the samples into a buffer until the buffer is full of samples. Then, the server causes the stored samples to be combined and placed into an IP packet. The packet is sent in response to a request by personnel at a location remote from the cable modem. The packet is received at the remote location, and the data contained therein is displayed for use by the personnel in diagnosing a potential problem in the IP network. The display may be a constellation plot.

The technician's remote device wherefrom the request was placed may include a table, having a modem identifier field, the performance data being associated with the identifier corresponding to the modem whence the data came. The table may also contain a node and branch identifier for each corresponding modem.

### CROSS REFERENCE TO RELATED APPLICATION

This application claims the benefit of priority under 35 U.S.C. 119(e) to the filing date of Bestermann, et al., U.S. provisional patent application No. 60/415,344 entitled “IP Constellation Plotter”, which was filed Oct. 1, 2002, and is incorporated herein by reference in its entirety.

### FIELD OF THE INVENTION

The present invention generally relates to monitoring RF health in a DOCSIS network, and more particularly, to using a DOCSIS cable modem in a CMTS/cable modem network to collect RF data and send said data to a remote location using Internet protocol (“IP”).

### BACKGROUND

As the use of broadband communication systems continues to grow, so does the size and geographical extent of the networks that facilitate the systems. As with anything in the physical world, degradations, malfunctions and damage may occur to the hardware that make up the networks. In addition, the ever-growing number of customers that are being added to, and thus supported by, a given network places demands on the hardware, the performance of which typically declining with additional load that exceeds the original design basis.

Communication systems and networks are typically designed with redundancy so that if part of the network is out of service other pieces and parts of the same network and system can support the same customers that are normally served by the out-of-service components. However, when such a scenario arises, the performance of the networks to all the customers, especially those who are served by the now-overloaded portion, tends to noticeably decline. When such a decrease in performance is noticed by a user, or subscriber, one or more users typically notify the system operator that performance of the system is not acceptable. Following such a notification, the system operator typically sends personnel to the location of the user or users who are experiencing problems to diagnose the problem. As this is typically done during normal business hours, diagnostic and repair activities are typically only performed during limited time of the day, unless overtime pay is provided to the technician that physically goes to the trouble site. Employers are typically averse to paying overtime, since is raises the cost of doing business. This extra cost is passed on to the customer, which makes the employers less competitive against other providers. Thus, employers may need maintain more employees on the payroll to adequately address outages that they would otherwise have to if the amount of personnel labor required to adequately address an outage was reduced. In addition to personnel costs, the transportation costs, i.e. those related to the purchase, operation and maintenance of trucks and related equipment, is also a cost that is passed on to the customer.

Therefore, there is a need for a method and system for remotely monitoring the performance of communication networks so that personnel can determine the cause of reduced network performance due to damage, normal hardware degradation, traffic routing, malfunctioning of network equipment, or other causes of degraded network performance. Furthermore, there is a need to provide a means for monitoring said network performance using readily available equipment, rather than expensive specialized equipment that has to be deployed in the field. Moreover, the cause of degraded absence of network performance at a particular customer premises may be caused by degradation or component failure at a location far from the complaining customer's premises. Thus, there is also a need for a method and system for determining the location of the defective component or traffic bottleneck from a single location.

### SUMMARY

A method and system is disclosed that uses existing components typically found in a Data Over Cable Service Interface Specification (“DOCSIS”) cable modem. A typical DOCSIS modem typically includes a performance data register that is continually refreshed with RF performance data that can be plotted on an IQ Cartesian coordinate graph known in the art. A DOCSIS modem also typically includes a buffer that is used to store various data that is used to carry out standard DOCSIS functions within the modem.

These components are used to collect performance data and provide the same in response to a request by a remote computer-compatible device, such as a personal computer (“PC”), a personal digital assistant (“PDA”), or similar digital device configured to transmit and receive data over an IP network. The request is received over the IP network and processed by a server software application that resides in the modem. The server responds to the received request by instructing the samples of performance data generated in the performance register be stored to the buffer. When the buffer is full, the server converts the data stored in the buffer into an IP data packet and sends the packet to a client software application that resides on the devices that made the request.

As data packets are received by the client, they are mapped into a table, typically a three dimensional array, that associates a particular user device/cable modem identifier with the incoming performance data that corresponds to the modem having that identifier. The identifier is typically encoded into the modem, or other user device, and is sent in a packet header, or other similar messaging scheme, known in the art.

As performance data are received and tabularized, they can be provided in report format to a user interface, such as a computer monitor. A technician located at the user interface, which will typically be located at the data-requesting device, can analyze the report and determine where a problem exists in the infrastructure of the network without having to drive in a truck to a customer's premises to diagnose a problem or cause of degraded performance.

The data may be displayed in the form of a constellation plot known in the art. Such a plot may typically display a dot, or pixel, on a visual display screen, at a location that corresponds to a particular symbol, as used in a 256 QAM signaling scheme, for example, as known in the art. Accordingly, when a symbol is being transmitted as it should be, the corresponding dot would appear as a single pixel at a predetermined location on the screen that is set aside for that particular symbol. Thus, if all 256 symbols are being ideally transmitted during the time that data is sampled in response to a request, 256 corresponding pixels would be illuminated on the computer screen, each at their designated locations on the screen.

However, if some symbols are not being ideally transmitted, there may be a larger blurred dot centered at the corresponding location on the screen, which would indicate that either the I or the Q component of the RF signal is not being transmitted properly every time it is transmitted. In another scenario, if only one pixel corresponding to a given symbol is illuminated or otherwise displayed, but at the incorrect location on the screen, a technician could reasonably determine that.the symbol is being transmitted consistently wrong.

Thus, a technician can determine if a component that serves the designated modem is not operating properly if only the plot for that particular modem appears to be blurred. Similarly, if the plot for many modems that are near to one another physically appear to blurred, a technician could reasonably determine that a component that serves the affected modems is defective, thus helping to narrow down the cause and location of the degraded performance. This determination can be performed at any time and at any location where the technician can access an IP network, such as the Internet, for example.

### BRIEF DESCRIPTION OF THE DRAWINGS

FIG. 1 illustrates a system for sending network performance data in an IP format over a DOCSIS network.

FIG. 2 illustrates a plot of symbols indicating RF performance.

FIG. 3 illustrates a flow chart showing steps included in a method for sending network performance data in an IP format over a DOCSIS network.

### DETAILED DESCRIPTION

As a preliminary matter, it will be readily understood by those persons skilled in the art that the present invention is susceptible of broad utility and application. Many methods, embodiments and adaptations of the present invention other than those herein described, as well as many variations, modifications, and equivalent arrangements, will be apparent from or reasonably suggested by the present invention and the following description thereof, without departing from the substance or scope of the present invention.

Accordingly, while the present invention has been described herein in detail in relation to preferred embodiments, it is to be understood that this disclosure is only illustrative and exemplary of the present invention and is made merely for the purposes of providing a full and enabling disclosure of the invention. The following disclosure is not intended nor is to be construed to limit the present invention or otherwise to exclude other embodiments, adaptations, variations, modifications and equivalent arrangements, the present invention being limited only by the claims appended hereto and the equivalents thereof.

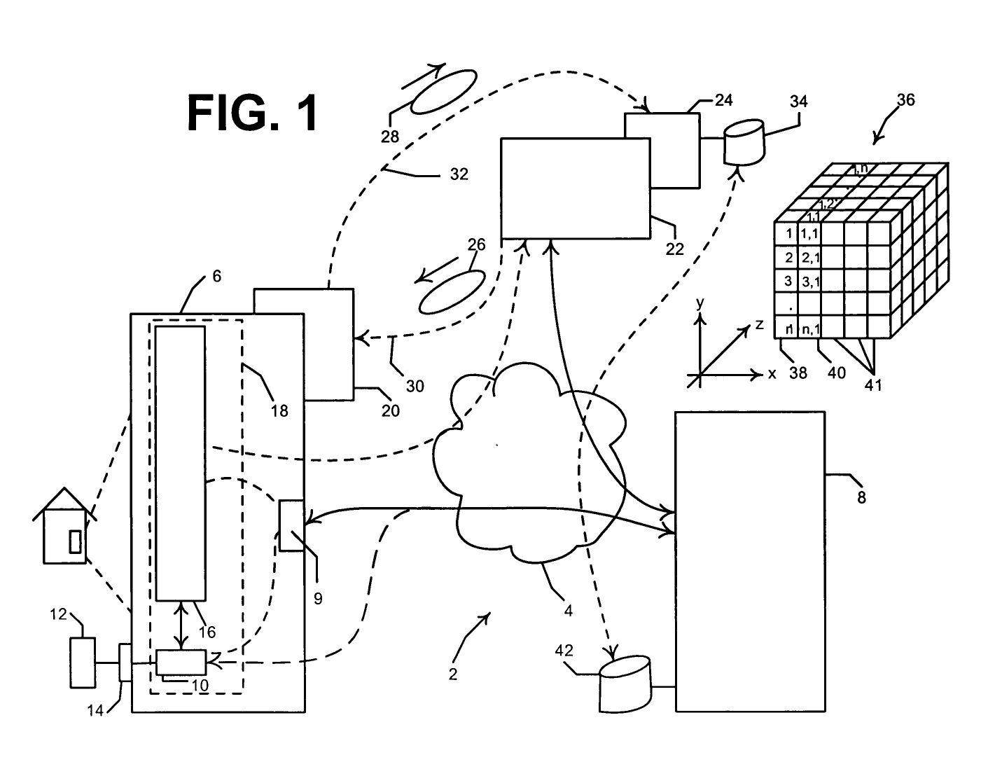

Turning now to the figures, FIG. 1 illustrates a system 2 for sending network performance data in an IP format over a DOCSIS network 4. In a typical DOCSIS network, a plurality of cable modems 6 are served by a cable modem termination system (“CMTS”) 8 located at a head end location or central office. Only one cable modem 6 is shown for clarity, but it will be appreciated by those skilled in the art that many cable modems 6 are typically served by a node, which in the figure would be part of network 4. Modem 6 is typically coupled to network 4 at an RF port 9.

A typical cable modem 6 known in the art includes a register 10 that contains RF performance data. This data is typically refreshed at a predetermined sample rate as new samples overwrite old ones are received at port 9. This facilitates a technician connecting a portable diagnostic device 12 to diagnostic port 14 on the cable modem 6, the diagnostic port being configured to provide each sample of RF performance data at its output as the samples are refreshed in register 10. The technician's portable device 12 typically has a buffer that stores received RF performance data as they are provided at output port 14. Then, the technician can cause the portable diagnostic device 12 to perform analysis on the data for determining the health of the portion of network 4 that serves the cable modem 6 being tested.

In addition to register 10, cable modem 6 typically also contains a data buffer 16, the register and buffer typically being integrated into an application specific integrated circuit (“ASIC”) 18, which is coupled to port 9 by means and methods known in the art. Buffer 16 may be used for a variety of purposes within the cable modem, including standard computing purposes and operating system functions as needed by the internal circuitry of modem 6.

While it can be used for general purposes, buffer 16 also can be used to store multiple sequential samples of the RF performance data as contained in register 10 as discussed. Thus, instead of outputting each sample of data at port 14 as it is generated, multiple samples can be stored in buffer 16, and can then be transmitted as a group of samples simultaneously. Accordingly, instead of connecting a proprietary diagnostic tool 12 at port 14, performance data collected by register 10 can be transmitted anywhere on network 4, thus allowing the performing of diagnostic analysis at a location remote from the location of modem 6.

To facilitate the assembling and transmitting of the performance data as IP packets over network 4, server routine 20, resident in modem 6, is capable of controlling communication between modem 6 and a device 22 at a remote location. For example, a technician, who is proximate a PC or other computer-compatible device 22 and receives a trouble report while at home, work/office, or any location with Internet access, can send a request with the computer-compatible device to the modem(s) 6 that are associated with the trouble report, e.g., the modems of the users that report that there is trouble with their service.

A client software application 24 resident in the computer-compatible device 22 generates an IP message 26 addressed to one or more modems 6 that have reported trouble with service. Message 26 is received by server software application 20, which then instructs data in register 10 to be stored in buffer 16. When buffer 16 is full, server application 20 instructs the first full packet to be sent as an IP message 28 to client 24. It will be appreciated that the routing of messages 26 and 28 is shown as being between server 20 and client 24. However, those skilled in the art will appreciate that messages and other communication between components of network 4 are typically routed from devices, such as modem 6 and computer-compatible device 22 through CMTS 8. The routing along dashed lines 30 and 32 are given for convenience in showing that from the viewpoint of server 20 and client 24, they are communicating directly with one another.

Before sending message 26 to modem(s) 6, client application 24 generates table 34. Table 34 associates the modem(s) for which performance data in the form of IP packets/messages are to be collected with the samples of data that are received in IP packets 28. It will be appreciated, that since there will typically be multiple packets, each containing multiple samples of performance data, being transmitted to client 24, table 34 could be implemented as a three dimensional array so that multiple data samples corresponding to a particular modem 6 can be associated with that modem. An example of a data structure that could be used to implement table 34 is shown in table expansion 36.

Expansion 36 of table 34 includes a device column 38 for storing identifiers of the modems 6, or other network devices, for which performance data is to be stored. Each cell in column 40 stores the first performance data sample received from the modem to which it corresponds. Columns 41 can be used to store data corresponding to each modem identified in column 38, such as, for example, node and branch identifiers associated with the modems. Each cell in column 40 also is the first cell in a row 42 that is parallel to the z-axis, as indicated by the legend in the figure. Thus, a first data sample for a given modem 6, or other similar device, is stored in the cell of column 40 (parallel to the y-axis) corresponding to the given modem, with subsequent data samples being stored in cells of the row parallel to the z-axis that is anchored by the column 40 cell. Accordingly, the coordinates shown in the figure for the cells in column 40 and the top row 42—each cell in column 40 has a corresponding row 42—identify the device number and the data sample for a given device. For example, the first coordinate represents the device number and the second coordinate represents the sample number for device represented by coordinate one. It will be appreciated that the total number of devices that are represented in table 34 may be determined by the specific modems/devices 6 for which a technician requests data. The number of devices 6 in table 34 may be only one single device, or may be all the devices connected to network 4. Of course, it will be appreciated that when more devices are selected for which performance data is desired, the time to obtain and populate table 34 with the selected number of samples for each device will increase.

When table 34 has been populated, the remote device 22 may be used to perform mathematical, statistical or other types of analysis, which may then be a reviewed by a technician to determine whether, and to what extent, a problem exists with the infrastructure of network 4. The results of such analysis may include plotting the RF symbol response on a Cartesian coordinate graph having axis that correspond to the I and Q components of the symbols in a QAM symbol scheme.

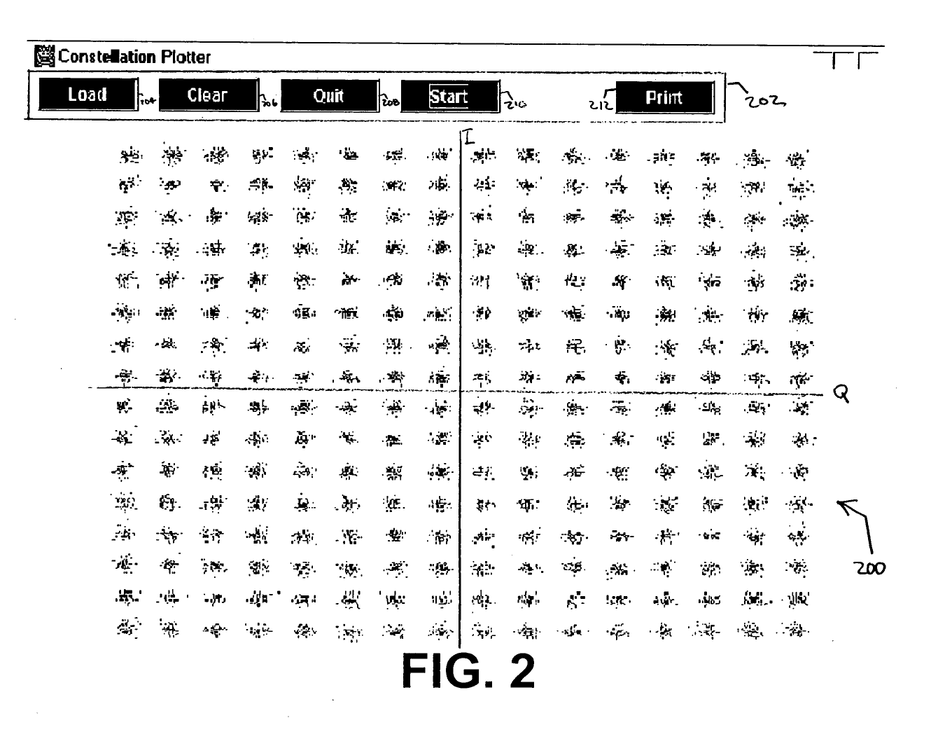

Such plots of the I and Q components are known in the art and are know as a constellation plot as shown in FIG. 2. FIG. 2 shows a constellation plot of signal modulation using 256QAM, which, as the term implies, uses 256 different symbols to transmit data. Since QAM techniques are generally known in the art, only a brief discussion of the same is presented here to introduce terms used to describe the plot in FIG. 2.

In QAM, a carrier signal is split so that the original carrier signal is produced at an output. The carrier is also shifted by 90 degrees and is produced at another output. A modulating signal is them applied to both the original, or ‘in phase’ carrier (the “I” carrier) and the carrier that has been shifted by 90 degrees (the “Q” carrier). The signal that modulates the carrier signals are typically digital messages known in the art as symbols. For example, in a 256 QAM scheme, each symbol would comprise eight bits of data. As each symbol is applied to a modulating section of a transmitting device, the most significant bits—the four-most significant in a 256 QAM scheme—are used to modulate the I carrier and the least significant bits are used to modulate the Q carrier. The two results of these modulations are then summed together and transmitted together. Thus, in-phase and quadrature component of a symbol are transmitted simultaneously to double the data rate for a given bandwidth system.

As with any communication system, distortion to the symbols can occur during transmission. Such distortion may be the result of noise, ingress, coherent interference, gain compression, phase noise and other types known in the art. The symbols that are used to transmit a signal can be plotted as described above. After an adequate number of symbols have been plotted, the constellation plot of perfectly transmitted symbols would appear as a singular dot for each symbol at evenly spaced locations about the I-Q axis in a grid-like fashion.

However, as discussed, noise and other distortion factors may cause a single dot to appear blurred. As multiple data samples are received by diagnostic equipment, a given symbol may have been transmitted multiple times as well, although most likely not as many times as the total number of received samples. As each data sample is received, it is plotted on the I-Q graph at a position corresponding to its I and Q components. Since noise and distortion will typically affect these components for a given symbol from data sample to data sample, the plot of each symbol, while being a single dot for each sample, will appear on a printed, screen, or other visual display as a plurality of dots. The shape or pattern that these dots form for each given symbol can be analyzed by a trained technician to determine what kind of signal distortion is present, where it originates, and whether it is tolerable. As can be seen in FIG. 2, each of the 256 ‘blurry’ areas in plot 40 represents a symbol corresponding to the I and Q components of the symbol as discussed above. It can be seen that for each symbol in plot 200, there are multiple dots, pixels, or other visual representations for each symbol. Each visual representation corresponds to a particular data sample, with the representation for each successive sample being retained such that the representations accumulate and can be viewed simultaneously. This allows a technician viewing plot 200 to determine the source of a problem affecting the RF performance of the signal stream of symbols.

Plot 200 could be displayed on a computer screen as shown in FIG. 2, with control buttons 202. Buttons 202 may comprise a load button 204, a clear button 206, a quit button 208, a start button 210 and a print button 212. A technician would typically select button 206 to clear the screen of previous plot data or any random noise that may have accumulated on the screen. Then, upon selecting the start button 210, the computer, by which the plot 200 is being displayed, sends a data request to a server software module at a remote location. As the server sends the requested symbol data, the computer that is displaying the plot receives the data with client software (typically the client software provides plot 200). When the technician determines that sufficient time has elapsed while collecting data to provide an adequate representation of RF performance, selecting load button 204 causes the data, which was being stored by the client software as it was being received, to be displayed on the computer screen as plot 200. The technician may then analyze the data by viewing the screen, or the technician may select print button 212 to cause plot 200 to be produced at a computer printer. This provides a means for record keeping and later analysis of the data. After viewing or printing plot 200, the technician may then select clear button 206 and retrieve more data from the same remote device, or even a different device, and perform analysis on the new data, or the technician may select quit button 208 and exit the client software.

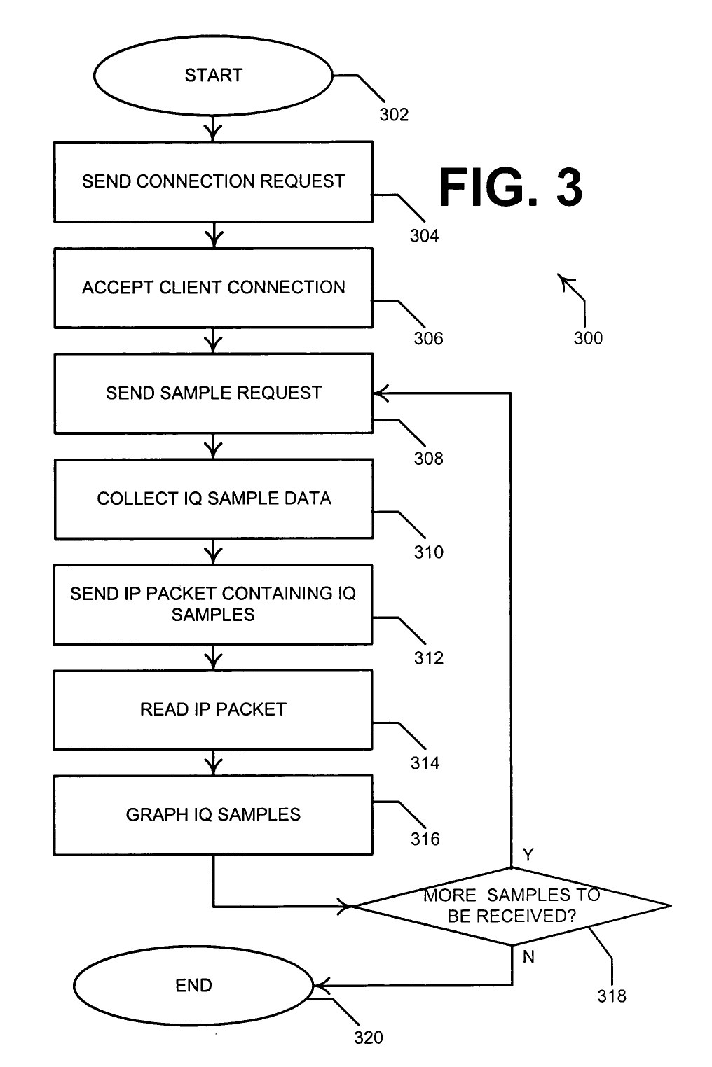

To illustrate the process of obtaining RF performance data remotely, FIG. 3 illustrates the steps of a method to obtain the data remotely. Method 300 begins at step 302. At step 304, a technician enters a request for RF performance data of a network component device, such as, for example, a cable modem, at a location remote from said device, and the device into which the technician enters the request sends a connection request to the remote device. At step 306, the remote device receives the connection request and accepts said request. The format for sending and receiving the connection request between the technician's device and the remote network device uses IP techniques known in the art. This provides the technician with a wide variety of devices and locations from which to diagnose network RF performance, as any location having Internet access will provide interface capability to the network device being monitored.

At step 308, following acceptance and connection at the server (active executable software application at cable modem or other remote device) of the client, which made the connection request at step 306, the client sends a sample request to the server. The request may include a request for a certain number of samples of data, and the parameters for which additional data should be sent. For example, although the device can be determined because each device in a network will typically have an identifier associated with, thereby facilitating the technician in specifying the device or devices to be monitored, the remote device may also be associated with particular nodes, branches geographical regions, etc. These data corresponding to the additional data may not actually be sent from the remote device, but may be remotely retrieved from a database 42 maintained at CMTS location 8, as shown in FIG. 1. Database 42 may typically associate a particular device 6 with particular components of network 4, such that a trained technician reviewing a constellation plot 200 as shown in FIG. 2. can determine whether a problem exists with the remote device, the supporting portions of network 4 or both. This facilitates the technician remotely monitoring the RF performance of the portions of network 4 that support device 6 to in determining whether there is a RF problem in the network, and, if so, approximately where the problem is in terms of the network, logically and/or geographically. Thus, even if it is determined that personnel may have to physically visit the remote location of the remote device 6 or some other portion of network 4, such personnel can be armed with knowledge of a probable diagnosis, probable location and the parts required to fix the problem if necessary.

Returning to FIG. 3, the client software at the technician's location responds to the sample request sent at step 308 and begins collecting and storing at step 310 symbol data into register 10 and buffer 16 as discussed above in reference to FIG. 1. When buffer 16 has filled with symbol data, this data is sent at step 312 shown in FIG. 3 as an IP packet 28 to the client 24 at remote device location 22 as shown in FIG. 1. It will be appreciated that remote device 6 and technician device 22 are physically connected to CMTS 8, such that transfer of messages occurs through the CMTS. However, the broken lines 30 and 32 are shown to indicate the server 20 and client 24 are logically connected to one another. Returning to FIG. 3, when a packet of data has been sent, the client software reads the incoming packet at step 314 and generates a graphical output of the incoming data at step 316. As discussed above, there will typically be multiple incoming packets of symbol data, the number of samples being based on the number and sample rate requested by the technician at step 308.

As the packets arrive at the client software, they may be stored until all the sample request have been received, at which time all the received samples are plotted on a visual display device. Alternatively, incoming packets may be plotted as they are received in real time, or pseudo real time (sample rate selected my be low so that there is a visually perceptible delay between the plotting of samples). After the samples contained in an IP packet have been plotted, routine 300 determines at step 318 whether there are more samples to be received, based on the number of samples requested and entered at step 308. If the requested number of samples have been received, the routine ends at step 320. If there are more samples to be received, the routine loops back to step 308 so the client software can send a request for more samples. It will be appreciated that as shown, step 308 comprises the entering of a sample request by a technician as well as the actual sending of the request from the client to the server. Since communication between the client and server occurs using IP, the two software modules are in communication as long as the session that was stated at step 306 is active. Thus, to minimize the storage overhead required by the client software at the remote device, the client may send a request for one packet at a time; sending requests for further packets upon receipt of a single packet. Alternatively, the server software may be configured to receive an entire request, containing the total number of packets to send, and store said request inside the remote device. Thus, a continuous stream of packet data containing symbol I-Q data would be sent to the client software, thereby speeding the transfer of said data.

These and many other objects and advantages will be readily apparent to one skilled in the art from the foregoing specification when read in conjunction with the appended drawings. It is to be understood that the embodiments herein illustrated are examples only, and that the scope of the invention is to be defined solely by the claims when accorded a full range of equivalents.

I claim:

1. A system for providing RF network performance data in a communication network comprising:
a user network device having a register that can be continually updated with samples of network performance data generated at said user network device;
means for storing multiple samples of the network performance data, the storing means being coupled with the register to facilitate the transfer of data from the register to the storing means; and
means, coupled to the network, for operating a server software program for placing network data stored in the storing means into a data packet or packets and for providing said data packet or packets to the communication network in response to a remotely placed request for data performance data.

2. A method for remotely monitoring the performance of a portion of an RF network, comprising:
compiling a table of information related to a plurality of user devices connected to the network, said table configured for associating multiple samples of network performance data, wherein each if the samples corresponds to one of the user devices, with an identifier of the user device to which each said sample of performance data corresponds;
requesting performance data corresponding to at least one of the user devices, the request being entered at a location remote from said at least one of the user devices for which performance data is being requested;
collecting samples of performance data at each of the user devices for which performance data has been requested;
assembling the collected samples of performance data at each of the user devices for which performance data has been requested into a data packet or packets;
sending the data packet or packets containing performance data from the at least one of the plurality of user devices to the remote location in response to the request for performance data;
receiving the packet or packets of data at the remote location from which the performance data was requested;
mapping the received packet or packets of data into the table;
generating a report based on the samples of performance data received in the data packets; and
presenting the results of the report with a user interface.

3. The method of claim 2 further comprising:
selecting one or more numerical functions for manipulating the performance data corresponding to the at least one of the plurality of user devices for which the performance data was requested; and
performing the selected numerical function or functions on performance data in the table that corresponds to the requested user device or devices in response to the selected numerical function or functions.

4. The method of claim 2 further comprising determining whether a problem exists in the network based on the presentation of the generated report.

5. The method of claim 2 wherein the performance data is IQ data corresponding to symbol data in a QAM modulation scheme.

6. The method of claim 5 wherein the QAM modulation scheme is 256QAM.

7. The method of claim 2 wherein the request for performance data is placed using a personal computer.

8. The method of claim 2 wherein the request for performance data is placed using a telephone.

9. The method of claim 2 wherein the data packet or packets are IP data packets.

10. The method of claim 2 wherein the report is displayed on a computer monitor.

11. The method of claim 2 wherein the report is displayed using a printer.

12. The method of claim 2 wherein the report is displayed using a plotter.

13. A system for providing RF network performance data in a communication network comprising:
a user network device having a register that can be continually updated with samples of network performance data generated at said user network device;
means for storing multiple samples of the network performance data, the storing means being coupled with the register to facilitate the transfer of data from the register to the storing means;
means, coupled to the network, for operating a server software program for placing network data stored in the storing means into a data packet or packets and for providing said data packet or packets to the communication network; and
a remote means, coupled to the network, for operating a client computer program for generating a user-device data table, for receiving the data packet or packets from the communication network, for decoding the data from the data packet or packets and for updating said user-device data table.

14. The system of claim 13 wherein the user network device further comprises an ASIC, wherein the ASIC includes the register.

15. The system of claim 13 wherein the storage means is a computer memory device.

16. The system of claim 15 wherein the computer memory includes an integrated circuit.

17. The system of claim 15 wherein the computer memory includes a disk drive.

18. The system of claim 13 wherein the means for operating a server program includes a microprocessor coupled to the storage means and coupled to the network, the storage means being adapted for storing the server software program and the microprocessor being coupled to the network through a data port.

19. The system of claim 13 wherein the remote means is a personal computer.

20. The system of claim 13 wherein the remote means is a telephone.

21. The system of claim 13 wherein the remote means is a Personal Digital Assistant (“PDA”).

22. The system of claim 13 wherein the data packet or packets are IP data packets.

23. The system of claim 13 wherein the user device includes the register, the storage means and the means for operating the server software.

24. A method for remotely monitoring the performance of a portion of an RF network having a plurality of user devices, comprising:
requesting performance data corresponding to at least one of the user devices, the request being entered at a location remote from said at least one of the user devices for which performance data is being requested;
receiving a packet or packets of data at the remote location wherefrom the performance data was requested, the packet being a data packet containing performance data associated with the at least one of the user devices for which the performance data was requested;
mapping samples within the received packet or packets of data into a table, the table configured such that a sample or samples of data corresponding to each of the plurality of user devices can be associated with a user device identifier or identifiers, which is/are associated with the user device or devices to which the sample or samples correspond; and
generating a report based on the data mapped into the table for a given at least one of the user devices.

25. The method of claim 24 wherein the performance data is IQ data corresponding to symbol data in a QAM modulation scheme.

26. The method of claim 25 wherein the QAM modulation scheme is 256QAM.

27. The method of claim 24 wherein the request for performance data is placed using a personal computer.

28. The method of claim 24 wherein the request for performance data is placed using a telephone.

29. The method of claim 24 wherein the request for performance data is placed using a Personal Digital Assistant (“PDA”).

30. The method of claim 24 wherein the data packet or packets are IP data packets.

31. The method of claim 24 further comprising determining whether a problem exists in the network based on the generated report.

32. The method of claim 24 wherein the report is displayed on a computer monitor.

33. The method of claim 24 wherein the report is displayed using a printer.

34. The method of claim 24 wherein the report is displayed using a plotter.

35. A method for remotely monitoring the performance of a portion of an RF network having a plurality of network devices, comprising:
receiving a request for performance data corresponding to at least one of the user devices, the request being entered at a location remote from said at least one of the user devices for which performance data is being requested;
collecting samples of performance data at each of the user devices for which performance data has been requested;
assembling the collected samples of performance data at each of the user devices for which performance data has been requested into a data packet or packets; and
sending the packet or packets containing performance data from the at least one of the plurality of user devices to the remote location in response to said request for performance data.

36. The method of claim 35 wherein the performance data is IQ data corresponding to symbol data in a QAM modulation scheme.

37. The method of claim 36 wherein the QAM modulation scheme is 256QAM.

38. The method of claim 35 wherein the request for performance data is placed using a personal computer.

39. The method of claim 35 wherein the request for performance data is placed using a telephone.

40. The method of claim 35 wherein the request for performance data is placed using a Personal Digital Assistant (“PDA”).

41. The method of claim 35 wherein the data packet or packets are IP data packets.
